(19) United States
(12) Patent Application Publication
(10) Pub. No.: US 2015/0143167 A1
(43) Pub. Date: May 21, 2015

(54) STORAGE CONTROL APPARATUS, METHOD OF CONTROLLING STORAGE SYSTEM, AND COMPUTER-READABLE STORAGE MEDIUM STORING STORAGE CONTROL PROGRAM

(71) Applicant: FUJITSU LIMITED, Kawasaki-shi (JP)

(72) Inventors: Chikashi Maeda, Kawasaki (JP); Hidejirou DAIKOKUYA, Kawasaki (JP); Kazuhiko IKEUCHI, Kawasaki (JP); Kazuhiro URATA, Kawasaki (JP); Yukari Tsuchiyama, Kawasaki (JP); Takeshi WATANABE, Kawasaki (JP); Norihide KUBOTA, Kawasaki (JP); Kenji KOBAYASHI, Kawasaki (JP); Ryota TSUKAHARA, Kawasaki (JP)

(21) Appl. No.: 14/533,158

(22) Filed: Nov. 5, 2014

(30) Foreign Application Priority Data
Nov. 18, 2013 (JP) 2013-237982

(51) Int. Cl. G06F 11/20; G06F 3/06

(52) U.S. Cl. CPC G06F 11/2094; G06F 3/0617; G06F 3/0647; G06F 3/0689
USPC 714/6.22

(57) ABSTRACT

A storage control apparatus for controlling a storage system including a plurality of storage devices includes a monitor unit that collects statistics from each of the storage devices; and a selection unit that, in the event of a failure of any of the storage devices, selects a storage device to which data in the failed storage device is to be reconstructed, based on the statistics collected by the monitor unit.

### CROSS-REFERENCE TO RELATED APPLICATION

This application is based upon and claims the benefit of priority of the prior Japanese Patent application No. 2013-237982, filed on Nov. 18, 2013, the entire contents of which are incorporated herein by reference.

### FIELD

The embodiments discussed herein are directed to a storage control apparatus, a method of controlling a storage system, and a computer-readable storage medium storing a storage control program.

### BACKGROUND

As information and communication technology (ICT) systems have become increasingly prevalent, disk array apparatuses including a plurality of storage devices such as hard disk drives (HDDs) (hereinafter collectively referred to as “disks”) have been widely used. A typical disk array apparatus records redundant data on two or more disks using redundant arrays of inexpensive disks (RAID) technology to ensure the data integrity.

If any disk fails in a disk array apparatus storing redundant data, the disk array apparatus reconstructs the data stored on the failed disk to another disk, such as a spare disk called a hot spare. This process is generally called rebuild. Rebuild restores data redundancy.

FIG. 19 illustrates an example layout of a RAID 1 (mirroring) configuration in a conventional disk array apparatus 102.

The disk array apparatus 102 includes three disks 105-0 to 105-2 (hereinafter also referred to as “disk #0”, “disk #1”, and “spare disk”, respectively).

The disks 105-0 to 105-2 are segmented into regions, which are hereinafter referred to as “chunks”. A suit of a group of chunks and a spare region at the same relative positions in the disks 105-0 to 105-2 is referred to as a “chunk set”. Each chunk has a size of, for example, several tens of megabytes (MB) to one gigabyte (GB).

In the example in FIG. 19, chunks A and A′ that define one chunk set store redundant data. If the disk 105-0 or 105-1 fails, the data on the failed disk 105-0 or 105-1 is reconstructed to the spare chunks on the disk 105-2 in the chunk sets.

For example, if the disk 105-0 fails in the normal RAID 1 configuration as shown in FIG. 19, 30 chunks of data must be read from the disk 105-1 and be written to the spare disk 105-2 for rebuild.

The time required for rebuild has been increasing with the increasing storage capacity of recent storage systems. Accordingly, there has been a need for a shorter rebuild time.

To meet this need, a technique called “fast rebuild” has been increasingly employed. This technique reduces the rebuild time by defining a RAID group including a number of disks larger than the number of constituent disks in a conventional RAID configuration to distribute a disk load associated with rebuild.

As used herein, the term “number of constituent disks in a conventional RAID configuration” refers to, for example, two disks for RAID 1, four disks for RAID 5 (3D+1P), or six disks for RAID 6 (4D+2P) (where D is a data disk, and P is a parity disk).

FIG. 20 illustrates an example layout of a RAID group in a conventional fast-rebuild-compatible disk array apparatus 102′. This example employs a RAID 1 configuration.

The disk array apparatus 102′ consists of a fast-rebuild-compatible RAID group including five disks 105-0 to 105-4 (hereinafter referred to as “disks #0 to #4”.

In this configuration, one chunk set is composed of two redundant groups and one spare region.

The RAID group compatible with fast rebuild is hereinafter referred to as “virtual RAID group”.

In the example in FIG. 20, chunks A and A′ that define one chunk set store redundant data, and chunks B and B′ that define one chunk set store redundant data. For example, if the disk #0 fails, the data on the failed disk #0 is reconstructed to the spare chunks in the chunk sets.

In the virtual RAID group in FIG. 20, six chunks of data may be read from each of the disks #1 to #4 (i.e., three A′ chunks and three B′ chunks from each disk) and be written to the space regions.

A comparison between the disk array apparatuses 102 and 102′ in FIGS. 19 and 20 for rebuild performance per disk shows that the disk array apparatus 102′, which defines a virtual RAID group, has a 2.5 times higher rebuild performance (=30/(6 chunks×2 (read and write)). The disk array apparatus 102′ provides a higher rebuild performance with increasing number of disks that define the virtual RAID group.

Thus, a virtual RAID group including a large number of disks would provide improved rebuild performance.

Unfortunately, a load associated with input/output (I/O) operations may concentrate on a particular disk, depending on the scheme of assignment of user data to the virtual RAID group and the scheme of access thereto. Even if a virtual RAID group including a larger number of disks is provided, I/Os may concentrate on some disks. If all disks are uniformly used for rebuild, the rebuild speed is limited by the throughput of a disk at high load. Thus, the rebuild performance is limited by the disk performance, and therefore, the performance of other disks cannot be sufficiently utilized.

### SUMMARY

According to an aspect of the embodiments, provided is a storage control apparatus for controlling a storage system including a plurality of storage devices includes a monitor unit that collects statistics from each of the storage devices; and a selection unit that, in the event of a failure of any of the storage devices, selects a storage device to which data in the failed storage device is to be reconstructed, based on the statistics collected by the monitor unit.

According to another aspect of the embodiments, provided is a method of controlling a storage system including a plurality of storage devices includes collecting statistics from each of the storage devices; and in the event of a failure of any of the storage devices, selecting a storage device to which data in the failed storage device is to be reconstructed based on the collected statistics.

According to still another aspect of the embodiments, provided is a non-transitory computer-readable storage medium stores a storage control program for controlling a storage system including a plurality of storage devices. The storage control program causes a computer to execute collecting statistics from each of the storage devices; and in the event of a failure of any of the storage devices, selecting a storage device to which data in the failed storage device is to be reconstructed based on the collected statistics.

According to still another aspect of the embodiments, provided is a storage system including a plurality of storage devices; a monitor unit that collects statistics from each of the storage devices; and a selection unit that, in the event of a failure of any of the storage devices, selects a storage device to which data in the failed storage device is to be reconstructed, based on the statistics collected by the monitor unit.

The objects and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates the hardware configuration of an information processing system including a disk array apparatus according to an example of an embodiment;

FIG. 2 illustrates the functional blocks of a controller in the disk array apparatus according to an example of an embodiment;

FIG. 3 illustrates the layout of a RAID group in the disk array apparatus according to an example of an embodiment;

FIG. 4 illustrates a statistic control variable and disk load monitoring tables in the disk array apparatus according to an example of an embodiment;

FIG. 5 illustrates a target rebuild load table in the disk array apparatus according to an example of an embodiment;

FIG. 6 illustrates a rebuild load adjusting table in the disk array apparatus according to an example of an embodiment;

FIG. 7 is a flowchart of a disk load monitoring procedure executed by an I/O load monitor according to an example of an embodiment;

FIG. 8 is a flowchart of a statistic switching and clearing procedure executed by the I/O load monitor according to an example of an embodiment;

FIG. 9 is a flowchart of a fast rebuild optimizing procedure executed by a region-for-rebuild selector according to an example of an embodiment;

FIG. 10 illustrates a set of example values of the rebuild load adjusting table and the target rebuild load table in the disk array apparatus according to an example of an embodiment;

FIG. 11 illustrates a set of example values of the rebuild load adjusting table and the target rebuild load table in the disk array apparatus according to an example of an embodiment;

FIG. 12 illustrates a set of example values of the rebuild load adjusting table and the target rebuild load table in the disk array apparatus according to an example of an embodiment;

FIG. 13 illustrates a set of example values of the rebuild load adjusting table and the target rebuild load table in the disk array apparatus according to an example of an embodiment;

FIG. 14 illustrates a set of example values of the rebuild load adjusting table and the target rebuild load table in the disk array apparatus according to an example of an embodiment;

FIG. 15A illustrates a layout pattern table of the disk array apparatus according to an example of an embodiment before a disk failure;

FIG. 15B illustrates an example disk load monitoring table in the example in FIG. 15A;

FIG. 16A illustrates a layout pattern table of the disk array apparatus according to an example of an embodiment after a disk failure;

FIG. 16B illustrates an example disk load monitoring table in example in FIG. 16A;

FIG. 17 illustrates example calculated results during the fast rebuild optimizing procedure executed by the region-for-rebuild selector according to an example of an embodiment;

FIG. 18 illustrates an example layout pattern table after the fast rebuild optimizing procedure according to an example of an embodiment;

FIG. 19 illustrates an example layout of a RAID 1 configuration in a conventional disk array apparatus; and

FIG. 20 illustrates an example layout of a RAID group in a conventional fast-rebuild-compatible disk array apparatus.

### DESCRIPTION OF EMBODIMENTS

A storage control apparatus, a method of controlling a storage system, a non-transitory computer-readable storage medium storing a storage control program, and a storage system, according to some embodiments will now be described with reference to the accompanying drawings.

The following embodiments are illustrative only and are not intended to exclude various modifications and technical applications that are not explicitly shown in the embodiments. That is, the following embodiments can be modified in various ways (e.g., can be combined with various modifications) without departing from the spirit thereof.

### (A) CONFIGURATION

The configuration of a disk array apparatus 2 according to an example of an embodiment will now be described.

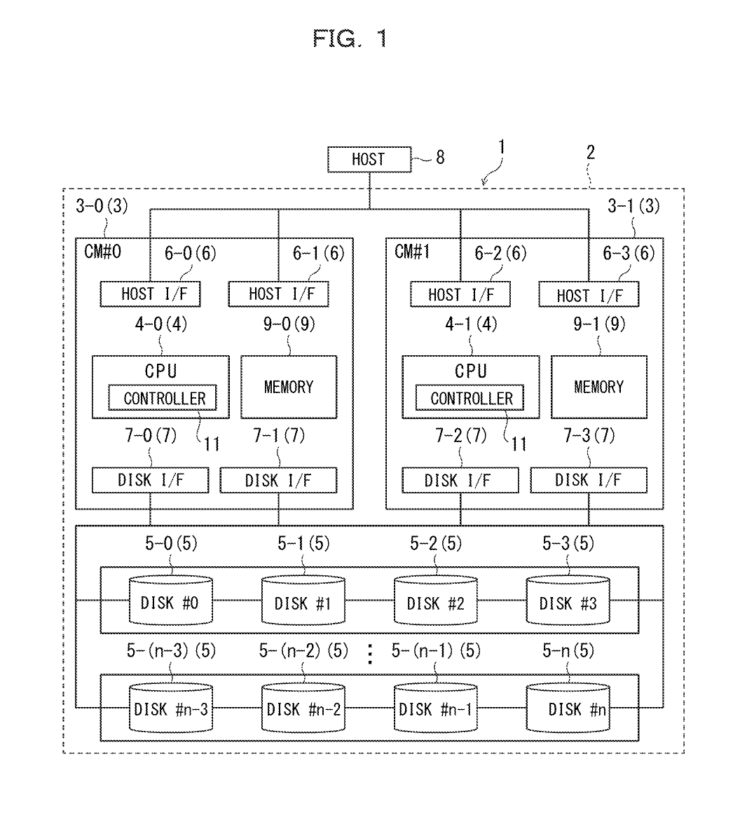

FIG. 1 illustrates the hardware configuration of an information processing system 1 including the disk array apparatus 2 according to this embodiment.

The information processing system 1 includes a host 8 and the disk array apparatus 2.

In the information processing system 1, the host 8 is connected to the disk array apparatus 2, for example, via a storage area network (SAN).

The host 8 is, for example, a computer (information processor) having a server function and communicates various types of data, such as small computer system interface (SCSI) commands and responses, with the disk array apparatus 2 using a storage connection protocol. The host 8 sends disk access commands (I/O commands) such as read/write commands to the disk array apparatus 2 to write and read data to and from a storage space provided by the disk array apparatus 2.

The disk array apparatus 2 provides a storage space for the host 8 and is connected to the host 8 via a network such as a LAN or SAN such that they can communicate with each other. The disk array apparatus 2 is a RAID array compatible with fast rebuild.

The disk array apparatus 2 includes control modules (CMs) 3-0 and 3-1 and disks (storage devices) 5-0, 5-1, . . . , and 5-n (where n is an integer of 3 or more).

The CMs 3-0 and 3-1 are controllers that control the internal operation of the disk array apparatus 2. The CMs 3-0 and 3-1 receive I/O commands such as read/write commands from the host 8 and perform various controls.

The CMs 3-0 and 3-1 define a duplex system. Normally, the CM 3-0 functions as the primary CM and controls the secondary CM, i.e., the CM 3-1, thereby managing the overall operation of the disk array apparatus 2. In the event of a failure of the CM 3-0, however, the CM 3-1 functions as the primary CM and takes over the operation of the CM 3-0.

The CM 3-0 includes host interfaces (I/Fs) 6-0 and 6-1, disk I/Fs 7-0 and 7-1, a central processing unit (CPU) 4-0, and a memory 9-0.

The host I/Fs 6-0 and 6-1 are interfaces for connecting the host 8 to the CM 3-0 via a network such as a SAN. The host I/Fs 6-0 and 6-1 connect the host 8 to the CM 3-0 using various communication protocols such as Fibra Channel (FC), Internet SCSI (iSCSI), Serial Attached SCSI (SAS), Fibre Channel over Ethernet® (FCoE), and Infiniband. The host I/Fs 6-0 and 6-1 define a duplex system. Even if one of the host I/Fs 6-0 and 6-1 fails, the CM 3-0 can continue to operate while the other host I/F is operating normally.

The disk I/Fs 7-0 and 7-1 are interfaces, such as expanders and I/O controllers (IOCs), for connecting the CM 3-0 to disks 5-0, 5-1, . . . , and 5-n (described later) using a communication protocol such as SAS. The disk I/Fs 7-0 and 7-1 control data communication with the disks 5-0, 5-1, . . . , and 5-n. The disk I/Fs 7-0 and 7-1 define a duplex system.

Even if one of the disk I/Fs 7-0 and 7-1 fails, the CM 3-0 can continue to operate while the other disk I/F is operating normally.

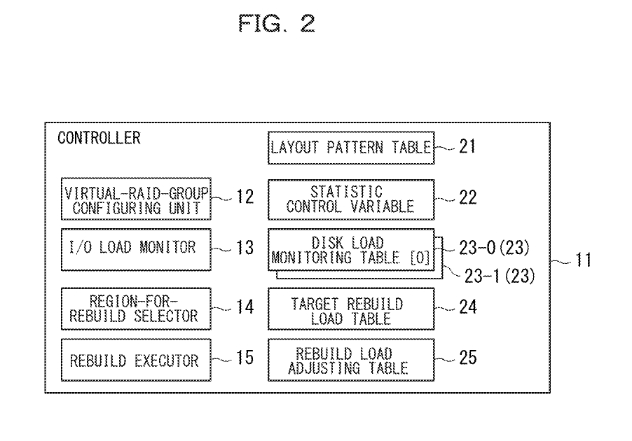

The CPU 4-0 is a processor that performs various controls and operations. The CPU 4-0 executes programs stored in a medium such as a read-only memory (ROM) (not shown) to implement various functions. The CPU 4-0 also executes programs to function as a controller (storage control apparatus) 11, as will be described later with reference to FIG. 2.

The memory 9-0 stores, for example, programs executed by the CPU 4-0, various types of data, and data acquired by the operation of the CPU 4-0. The memory 9-0 also functions as a storage unit for storing various variables and tables, as will be described later with reference to FIG. 2. The memory 9-0 may be a medium such as a random access memory (RAM).

The components of the CM 3-0, such as the host I/Fs 6-0 and 6-1 and the CPU 4-0, are in communication with each other using a protocol such as PCI Express (PCIe).

The CM 3-1 includes host I/Fs 6-2 and 6-3, disk I/Fs 7-2 and 7-3, a CPU 4-1, and a memory 9-1.

The host I/Fs 6-2 and 6-3 are interfaces for connecting the host 8 to the CM 3-1 via a network such as a SAN. The host I/Fs 6-2 and 6-3 connect the host 8 to the CM 3-1 using various communication protocols such as FC, iSCSI, SAS, FCoE, and Infiniband. The host I/Fs 6-2 and 6-3 define a duplex system. Even if one of the host I/Fs 6-2 and 6-3 fails, the CM 3-1 can continue to operate while the other host I/F is operating normally.

The disk I/Fs 7-2 and 7-3 are interfaces, such as expanders and IOCs, for connecting the CM 3-1 to the disks 5-0, 5-1, . . . , and 5-n (described later) using a communication protocol such as SAS. The disk I/Fs 7-2 and 7-3 control data communication with the disks 5-0, 5-1, . . . , and 5-n. The disk I/Fs 7-2 and 7-3 define a duplex system. Even if one of the disk I/Fs 7-2 and 7-3 fails, the CM 3-1 can continue to operate while the other disk I/F is operating normally.

The CPU 4-1 is a processor that performs various controls and operations. The CPU 4-1 executes programs stored in a medium such as a ROM (not shown) to implement various functions. The CPU 4-1 also executes programs to function as a controller 11, as will be described later with reference to FIG. 2.

The memory 9-1 stores, for example, programs executed by the CPU 4-1, various types of data, and data acquired by the operation of the CPU 4-1. The memory 9-1 also functions as a storage unit for storing various variables and tables, as will be described later with reference to FIG. 2. The memory 9-1 may be a medium such as a RAM.

The components of the CM 3-1, such as the host I/Fs 6-2 and 6-3 and the CPU 4-1, are in communication with each other using a protocol such as PCIe.

The disks 5-0, 5-1, . . . , and 5-n are disk drives that provide a storage space. The disk array apparatus 2 combines together the disks 5-0, 5-1, . . . , and 5-n to function as a logical volume.

The CMs are hereinafter denoted by reference numerals 3-0 and 3-1 for designation of a particular CM or by reference numeral 3 for designation of any CM.

The CPUs are hereinafter denoted by reference numerals 4-0 and 4-1 for designation of a particular CPU or by reference numeral 4 for designation of any CPU.

The disks are hereinafter denoted by reference numerals 5-0, 5-1, . . . , and 5-n for designation of a particular disk or by reference numeral 5 for designation of any disk.

The host I/Fs are hereinafter denoted by reference numerals 6-0 to 6-3 for designation of a particular host I/F or by reference numeral 6 for designation of any host I/F.

The disk I/Fs are hereinafter denoted by reference numerals 7-0 to 7-3 for designation of a particular disk I/F or by reference numeral 7 for designation of any disk I/F.

The RAMs are hereinafter denoted by reference numerals 9-0 and 9-1 for designation of a particular RAM or by reference numeral 9 for designation of any RAM.

The individual functional blocks of the controller 11 will now be described.

FIG. 2 illustrates the functional blocks of each controller 11 in the disk array apparatus 2 according to this embodiment.

The controller 11 monitors the load on each of the disks 5 that define the virtual RAID group, selects the optimum spare regions for rebuild based on collected statistics, and executes the fast rebuild of the disk array apparatus 2.

As used herein, the term “virtual RAID group” is a fast-rebuild-compatible RAID group composed of a number of disks larger than the number of constituent disks in a conventional RAID configuration (i.e., a number of disks larger than the redundancy of the RAID level). The disk array apparatus 2 according to this embodiment defines a virtual RAID group to distribute a disk load associated with rebuild.

The controller 11 includes a virtual-RAID-group configuring unit 12, an I/O load monitor 13, a region-for-rebuild selector 14, a rebuild executor 15, a layout pattern table 21, a statistic control variable 22, disk load monitoring tables 23, a target rebuild load table 24, and a rebuild load adjusting table 25.

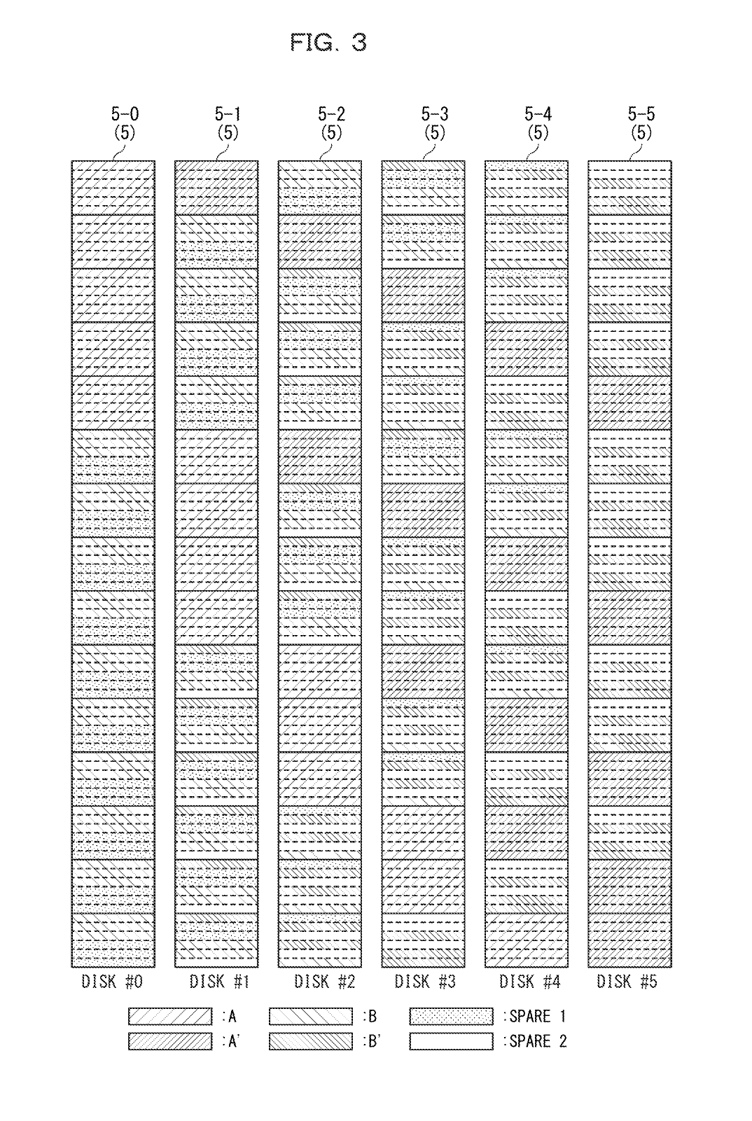

The virtual-RAID-group configuring unit 12 configures the layout of the virtual RAID group and stores the layout in the layout pattern table 21, as will be described later with reference to FIG. 3. The virtual-RAID-group configuring unit 12 creates the layout using a layout-creating algorithm known in the art. The layout-creating algorithm used by the virtual-RAID-group configuring unit 12 is known in the art and is therefore not described herein.

The layout pattern table 21 stores the layout of the RAID group as shown in FIG. 3 in any format.

FIG. 3 illustrates the layout of the RAID group in the disk array apparatus 2 according to this embodiment.

This disk array apparatus 2 employs a RAID 1 configuration. In the disk array apparatus 2, six disks 5, i.e., the disks 5-0 to 5-5, define a virtual RAID group, and spare regions 1 and 2 on two of the disks 5-0 to 5-5 are allocated to each chunk set. In the following description and drawings, the disks 5-0 to 5-5 are also referred to as “disks #0 to #5”, respectively.

In this example, chunks A and A′ that define one chunk set store redundant data, and chunks B and B′ that define one chunk set store redundant data. If any of the disks 5 fails, the data on the failed disk 5 is reconstructed to the spare chunks in the chunk sets. Each chunk set includes the spare regions 1 and 2 as spare chunks on two disks 5. The spare regions are labeled with numbers, such as 1 and 2 in this example.

If the number of disks of the virtual RAID group is n, and the number of redundant groups in each chunk set is k, these variables, the number of spare regions in each chunk set, and the total number of layout combinations of the chunk sets satisfy the relationship represented by the following equation:

$$Number of layout combinations = {\prod }_{i = 1}^{k} {}_{\{ n - 2 ( i - 1 ) \}}^{}{C}{}_{2}^{} \qquad ( 1 )$$

The number of spare regions in each chunk set is n−2k.

In the example in FIG. 3, the six disks 5-0 to 5-5 are used to define a virtual RAID group, and spare regions are allocated on two disks 5. In this example, the total number of layout combinations is calculated as follows: ₆C₂·₄C₂=90. Thus, FIG. 3 illustrates 90 layout combinations on each disk 5.

The statistic control variable 22 shown in FIG. 2 stores a variable indicating which disk load monitoring table 23-0 or 23-1 (described later) is active (in use). For example, if the statistic control variable 22 stores “0”, the disk load monitoring table 23-0 is active (in use) whereas the disk load monitoring table 23-1 is inactive (not in use). If the statistic control variable 22 stores “1”, the disk load monitoring table 23-1 is active (in use) whereas the disk load monitoring table 23-0 is inactive (not in use).

The disk load monitoring tables 23-0 and 23-1 store statistics for the disks 5 collected by the I/O load monitor 13, as will be described later.

The disk load monitoring tables are hereinafter denoted by reference numerals 23-0 and 23-1 for designation of a particular disk load monitoring table or by reference numeral 23 for designation of any disk load monitoring table. In the following description and drawings, the disk load monitoring table 23-0 is also referred to as “disk load monitoring table [0]”, and the disk load monitoring table 23-1 is also referred to as “disk load monitoring table [1]”.

The controller 11 includes a plurality of (in this example, two) disk load monitoring tables 23. The statistic control variable 22 indicates which disk load monitoring table 23 is currently in use (active). The active disk load monitoring table 23 is switched by the I/O load monitor 13 (described later) every specified time.

For example, if the specified time is 30 minutes, and if the controller 11 includes two disk load monitoring tables 23, the disk load monitoring tables 23 are reset alternately every one hour. In this case, if the active disk load monitoring table 23 is referred to at the start of fast rebuild, the fast rebuild can be optimized based on statistics containing at least 30 minutes of data constantly.

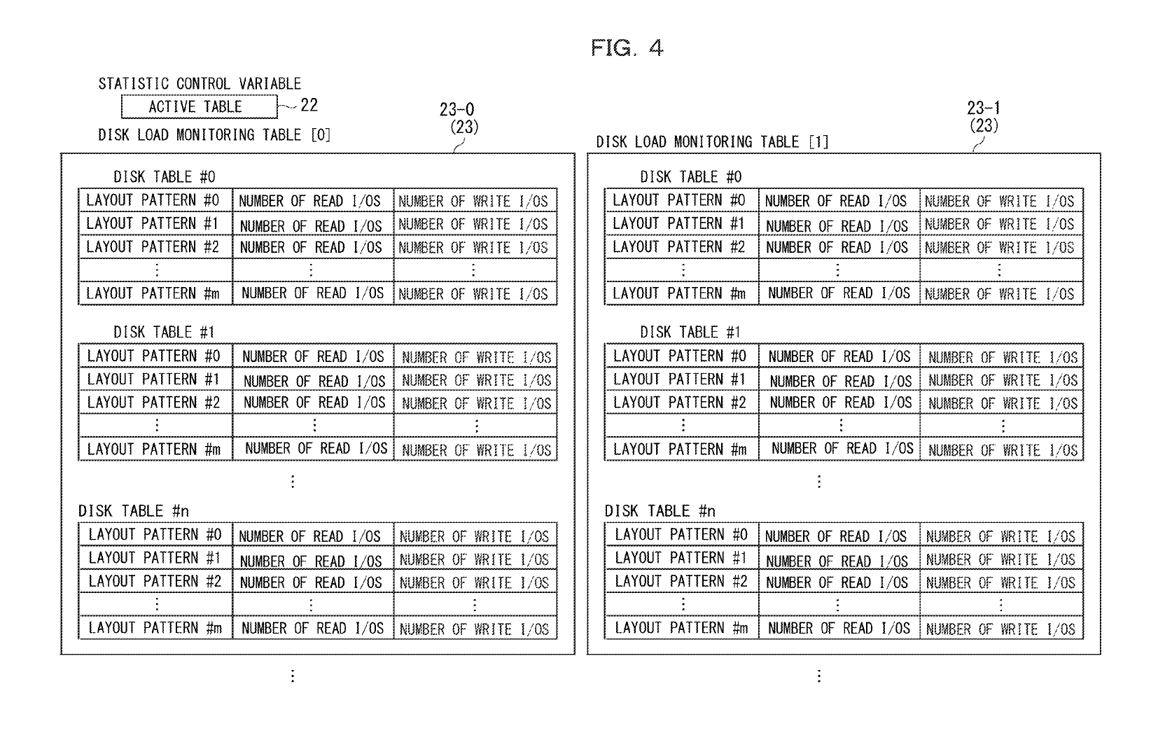

FIG. 4 illustrates the statistic control variable 22 and the disk load monitoring tables 23 in the disk array apparatus 2 according to this embodiment.

The example illustrated in FIG. 4 uses two disk load monitoring tables 23, i.e., the disk load monitoring tables [0] and [1]. The statistic control variable 22 stores “0” or “1”, which indicates the active disk load monitoring table 23. As described above, if the statistic control variable 22 stores “0”, the disk load monitoring table [0] is active, and if the statistic control variable 22 stores “1”, the disk load monitoring table [1] is active.

Each disk load monitoring table 23 stores the number of read I/Os and the number of write I/Os that have occurred on each disk 5. Each disk load monitoring table 23 includes a plurality of disk tables #0 to #n corresponding to the disks 5-0 to 5-n (disks #0 to #n), respectively. In the example in FIG. 4, the disk tables #0 to #n in each disk load monitoring table 23 store the numbers of read I/Os and the numbers of write I/Os of the disks 5-0 to 5-n, respectively.

Each of the disk tables #0 to #n stores the number of I/O commands (i.e., the number of read I/Os and the number of write I/Os) of each of layout patterns #0 to #m as shown in FIG. 3 (m=number of layout patterns−1; in the example in FIG. 3, m=89).

The old (inactive) disk load monitoring table 23 is cleared by the I/O load monitor 13 every predetermined time.

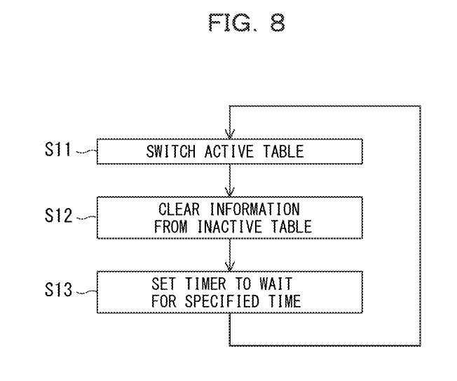

A procedure for switching and clearing the disk load monitoring tables 23 will be described later with reference to FIG. 8.

Although the following description will be directed toward an example where two disk load monitoring tables 23 are used, as illustrated in FIG. 4, it should be appreciated that more or less than two disk load monitoring tables 23 can be used.

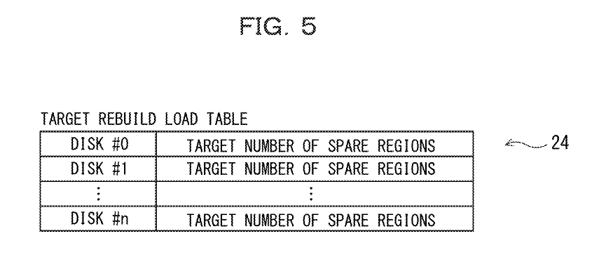

FIG. 5 illustrates the target rebuild load table 24 in the disk array apparatus 2 according to this embodiment.

The target rebuild load table 24 stores the target (expected) number of spare regions of each disk 5 when the region-for-rebuild selector 14 (described later) selects a spare region for rebuild during the fast rebuild. That is, the target rebuild load table 24 stores the target number of spare regions to be used on each disk 5. The target rebuild load table 24 is generated by the region-for-rebuild selector 14 (described later) from the statistics collected by the I/O load monitor 13. In this step, the region-for-rebuild selector 14 sets the target number of spare regions of each disk 5 such that the load associated with fast rebuild is distributed over the disks 5. The method for setting the target will be described later.

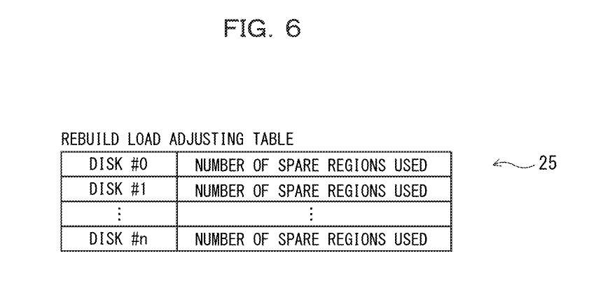

FIG. 6 illustrates the rebuild load adjusting table 25 in the disk array apparatus 2 according to this embodiment.

The rebuild load adjusting table 25 is a work table that stores the actual number of spare regions used on each disk 5 during the fast rebuild. The region-for-rebuild selector 14 (described later) adjusts the number of spare regions of each disk 5 stored in the rebuild load adjusting table 25 closer to the target (expected) number of spare regions stored in the target rebuild load table 24.

The I/O load monitor 13 shown in FIG. 2 monitors I/O commands executed on each of the disks 5 that define the virtual RAID group and records them in the form of statistics. Specifically, the I/O load monitor 13 records the number of read I/O commands and the number of write I/O commands from the host 8 in the disk load monitoring tables 23 described above. In this step, the I/O load monitor 13 adds the number of I/O commands of each layout pattern of each disk 5. As described later, the I/O load monitor 13 weights the number of I/O commands to be added depending on the block size requested by the I/O commands.

If a command is issued to any disk 5, the I/O load monitor 13 determines whether the command is a command for rebuild and, if so, does not increment the I/O command count.

The I/O load monitor 13 executes load monitoring when a command is actually issued to any disk 5, rather than when the disk array apparatus 2 accepts an I/O request from the host 8. This is because rebuild is more affected by the actual load on each disk 5 than by the load on the disk array apparatus 2.

If any disk 5 fails, the region-for-rebuild selector 14 determines the optimum spare regions for rebuild, based on the statistics collected by the I/O load monitor 13 to optimize the rebuild.

In this step, the region-for-rebuild selector 14 determines the number of spare regions to be selected for rebuild from each disk 5, based on the statistics collected by the I/O load monitor 13 and stores it in the target rebuild load table 24, as will be described later.

Specifically, the region-for-rebuild selector 14 copies the content of the active disk load monitoring table 23 between the disk load monitoring tables 23-0 and 23-1.

The region-for-rebuild selector 14 then adds the number of read I/Os of each layout pattern in the disk table for the failed disk 5 to the disk table for the disk 5 paired with the failed disk 5 in the data in the copy of the disk load monitoring table 23. The region-for-rebuild selector 14 adds only the number of read I/Os because read I/Os are normally executed only on one of a RAID redundant pair of disks 5 and it should therefore be taken into account that reads from the failed disk 5 are to be executed on the disk 5 paired therewith. It is not necessary to add the number of write I/Os because write I/Os are always executed on both of a redundant pair of disks 5.

The region-for-rebuild selector 14 adds up the number of read I/Os and the number of write I/Os of each disk 5 other than the failed disk 5 in the copy of the disk load monitoring table 23.

The region-for-rebuild selector 14 calculates the reciprocal of the ratio of the total number of I/Os of the disk array apparatus 2 to the number of I/Os of each disk 5 other than the failed disk 5 by equation (2):

Reciprocal of ratio={(total number of I/Os)/(number of I/Os of disk #0)}/[{(total number of I/Os)/(number of I/Os of disk #0)}+{(total number of I/Os)/(number of I/Os of disk #1)}+{(total number of I/Os)/(number of I/Os of disk #2)}+{(total number of I/Os)/(number of I/Os of disk #3)}+{(total number of I/Os)/(number of I/Os of disk #4)}+{(total number of I/Os)/(number of I/Os of disk #5)}] (2)

The reciprocal becomes larger as the numbers of I/Os of the disks 5 become smaller.

The region-for-rebuild selector 14 calculates the number of chunks to be used on each disk 5 as the total number of chunks requiring rebuild divided by the above ratio, used as a parameter, and stores it in the target rebuild load table 24.

Number of chunks to be used on each disk 5=total number of chunks requiring rebuild×reciprocal of ratio (3)

The region-for-rebuild selector 14 then sets the spare region for rebuild of each layout pattern to the lowest-numbered empty spare region and creates a rebuild load adjusting table 25.

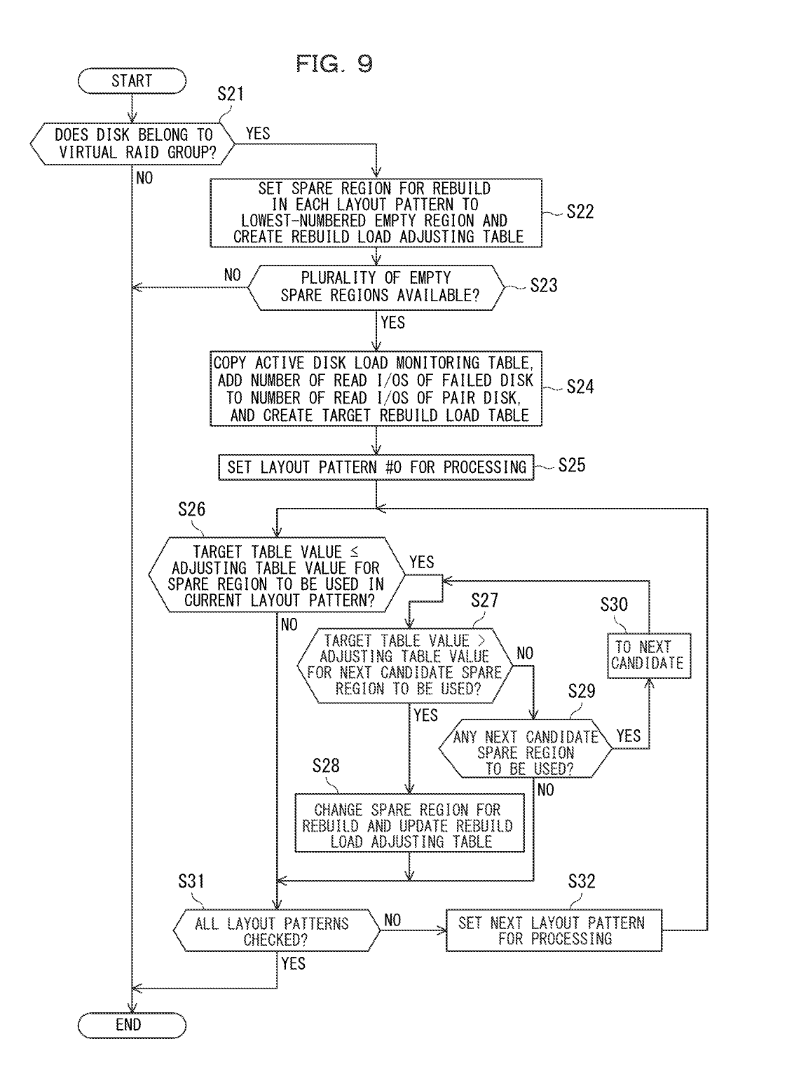

The region-for-rebuild selector 14 then sequentially updates the number of spare regions of each layout pattern in the rebuild load adjusting table 25 based on the target rebuild load table 24. Specifically, the region-for-rebuild selector 14 sequentially changes the set spare region of each layout pattern such that the number of spare regions approaches the target value in the target rebuild load table 24. This procedure executed by the region-for-rebuild selector 14 is hereinafter referred to as “fast rebuild optimizing procedure”. The fast rebuild optimizing procedure will be described in detail later with reference to FIG. 9.

The rebuild executor 15 executes rebuild by reconstructing the data on the failed disk 5 to the spare regions selected for rebuild by the region-for-rebuild selector 14. In this step, the rebuild executor 15 executes rebuild using a rebuild technique known in the art. The rebuild technique is known in the art and is therefore not described herein.

In this embodiment, the CPUs 4 of the CMs 3 execute a data duplicating program to function as the controller 11, the virtual-RAID-group configuring unit 12, the I/O load monitor 13, the region-for-rebuild selector 14, and the rebuild executor 15 described above.

The program for implementing the functions of the controller 11, the virtual-RAID-group configuring unit 12, the I/O load monitor 13, the region-for-rebuild selector 14, and the rebuild executor 15 described above is provided, for example, as being recorded on a computer-readable storage medium. Examples of such computer-readable storage media include flexible disks; optical discs such as CDs (e.g., CD-ROMs, CD-Rs, and CD-RWs), DVDs (e.g., DVD-ROMs, DVD-RAMs, DVD-Rs, DVD+Rs, DVD-RWs, DVD+RWs, and HD-DVDs), and Blu-ray discs; magnetic disks; and magneto-optical disks. A computer reads the program from the recording medium and then transfers and stores it in an internal storage device or an external storage device. Alternatively, the program may be recorded on a storage device (storage medium) such as a magnetic disk, optical disc, or magneto-optical disk and be provided from the storage device to a computer via a communication channel.

To implement the functions of the controller 11, the virtual-RAID-group configuring unit 12, the I/O load monitor 13, the region-for-rebuild selector 14, and the rebuild executor 15 described above, the program stored in the internal storage device (in this embodiment, the memories 9 of the CMs 3 or ROMs (not shown)) is executed by the microprocessor (in this embodiment, the CPUs 4 of the CMs 3) of the computer. Alternatively, the computer may read and execute a program recorded on a recording medium.

### (B) OPERATIONS

The operation of the controller 11 of the disk array apparatus 2 according to this embodiment will now be described.

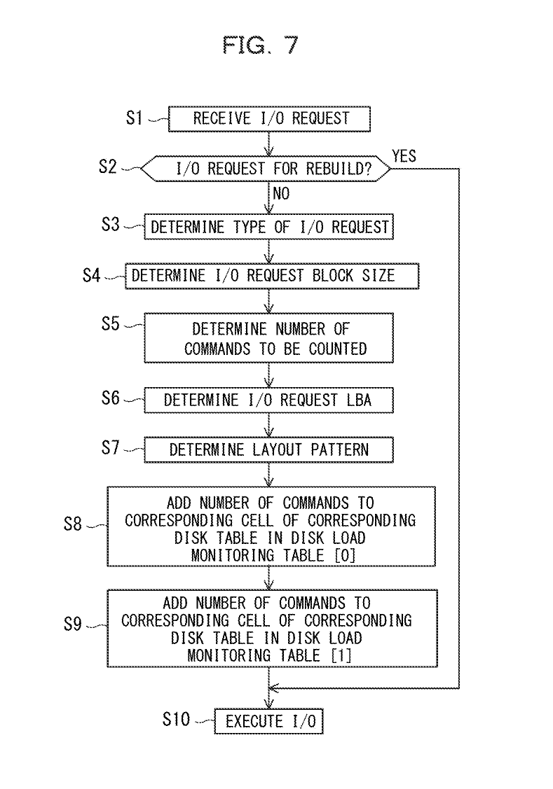

FIG. 7 is a flowchart of a disk load monitoring procedure executed by the I/O load monitor 13 according to this embodiment.

In step S1, the I/O load monitor 13 receives an I/O request from the host 8.

In step S2, the I/O load monitor 13 determines whether the I/O request received in step S1 is for rebuild.

If the I/O request received in step S1 is for rebuild (see the YES route in step S2), the I/O load monitor 13 ignores the I/O request, which is exempt from monitoring, and in step S10, the I/O request is executed.

If the I/O request received in step S1 is not for rebuild (see the NO route in step S2), the I/O load monitor 13, in step S3, determines whether the I/O request received in step S1 is a read I/O or a write I/O.

In step S4, the I/O load monitor 13 determines the requested block size based on the I/O request command received in step S1.

In step S5, the I/O load monitor 13 determines the number of commands to be added from the block size determined in step S4.

The number of commands to be added is determined from the number of I/O request blocks. The number of commands to be added may be associated with the number of I/O request blocks in advance, for example, as follows: one command for up to 8 KB, two commands for 8 to 32 KB, three commands for 32 to 128 KB, four commands for 128 to 512 KB, and five commands for 512 KB or more. This allows the load on the disks 5 to be monitored not only from the number of commands issued, but also from the block length transferred by each command.

In step S6, the I/O load monitor 13 determines the requested logical block address (LBA) based on the I/O request command received in step S1.

In step S7, the I/O load monitor 13 determines the layout pattern corresponding to the range specified by the request command received in step S1 from the requested LBA and the layout pattern table 21.

In this step, the I/O request to the volume of the disk array apparatus 2 is converted into an I/O request to a certain LBA of a certain disk 5 by referring to the layout of the virtual RAID group (see FIG. 3). Thus, the I/O load monitor 13 can determine the layout pattern corresponding to the I/O command by referring to the layout of the virtual RAID group recorded in the layout pattern table 21.

In step S8, the I/O load monitor 13 adds the number of commands determined in step S5 to the cell of the corresponding type of command (read or write) of the corresponding layout pattern of the corresponding disk 5 in the disk load monitoring table [0].

In step S9, the I/O load monitor 13 adds the number of commands determined in step S5 to the cell of the corresponding type of command (read or write) of the corresponding layout pattern of the corresponding disk 5 in the disk load monitoring table [1].

FIG. 8 is a flowchart of the statistic switching and clearing procedure executed by the I/O load monitor 13 according to this embodiment.

In step S11, the I/O load monitor 13 switches the active disk load monitoring table 23. Specifically, the I/O load monitor 13 activates the disk load monitoring table 23[1] if the disk load monitoring table 23[0] is active, and activates the disk load monitoring table 23[0] if the disk load monitoring table 23[1] is active.

In step S12, the I/O load monitor 13 clears the information from the disk load monitoring table 23 deactivated in step S11.

In step S13, the I/O load monitor 13 sets a timer for a specified time (for example, 30 minutes) to clear the disk load monitoring table 23 and waits for the specified time. After the specified time elapses, the I/O load monitor 13 returns to step S11 and switches the active disk load monitoring table 23.

Through the procedure in FIG. 8, the I/O load monitor 13 switches the active disk load monitoring table 23 and clears the old disk load monitoring table 23 every specified time.

FIG. 9 is a flowchart of the fast rebuild optimizing procedure executed by the region-for-rebuild selector 14 according to this embodiment.

In step S21, the region-for-rebuild selector 14 determines whether the disk 5 requiring rebuild belongs to the virtual RAID group.

If the disk 5 requiring rebuild does not belong to the virtual RAID group (see the NO route in step S21), the region-for-rebuild selector 14 terminates the fast rebuild optimizing procedure.

If the disk 5 requiring rebuild belongs to the virtual RAID group (see the YES route in step S21), the region-for-rebuild selector 14, in step S22, sets the spare region used for rebuild to the lowest-numbered empty spare region. The region-for-rebuild selector 14 then creates a rebuild load adjusting table 25 using the lowest-numbered spare region of each layout pattern.

In step S23, the region-for-rebuild selector 14 determines whether a plurality of spare regions is available in the virtual RAID group. For example, the region-for-rebuild selector 14 may determine whether a plurality of spare regions is available by referring to the information (not shown) about the configuration of the disk array apparatus 2. The information about the configuration of the disk array apparatus 2 is known in the art and is therefore not described in detail herein.

If a plurality of spare regions is not available in the virtual RAID group (see the NO route in step S23), the region-for-rebuild selector 14 terminates the fast rebuild optimizing procedure.

If a plurality of spare regions is available in the virtual RAID group (see the YES route in step S23), the region-for-rebuild selector 14, in step S24, copies the active disk load monitoring table 23. The region-for-rebuild selector 14 then adds the number of read I/Os of the failed disk 5 to the number of read I/Os of the pair disk 5 and creates a target rebuild load table 24.

In the subsequent steps, i.e., steps S25 to S32, the region-for-rebuild selector 14 sequentially executes the fast rebuild optimizing procedure on each layout pattern. In step S25, the region-for-rebuild selector 14 sets the initial layout pattern #0 (default) for processing.

In step S26, the region-for-rebuild selector 14 determines whether the value of the disk 5 having the set spare region in the rebuild load adjusting table 25 is larger than or equal to that in the target rebuild load table 24.

If the value in the rebuild load adjusting table 25 is not larger than or equal to that in the target rebuild load table 24 (see the NO route in step S26), the procedure transfers to step S31, as will be described later.

If the value in the rebuild load adjusting table 25 is larger than or equal to that in the target rebuild load table 24 (see the YES route in step S26), it is desirable to select fewer spare regions. Accordingly, in step S27, the region-for-rebuild selector 14 determines whether the value of the disk 5 having the next candidate spare region in the current layout pattern in the rebuild load adjusting table 25 is smaller than that in the target rebuild load table 24.

If the value in the rebuild load adjusting table 25 is smaller than that in the target rebuild load table 24 (see the YES route in step S27), it is desirable to select more spare regions. Accordingly, in step S28, the region-for-rebuild selector 14 changes the spare region for rebuild and updates the value in the rebuild load adjusting table 25. Specifically, in step S28, the region-for-rebuild selector 14 changes the spare region for rebuild in the layout pattern from the region set in step S22 to the region selected for the candidate in step S27. In the rebuild load adjusting table 25, the region-for-rebuild selector 14 decrements the value of the disk 5 having the region set in step S22 by one and increments the value of the disk 5 having the region selected for the candidate in step S27 by one.

If the value in the rebuild load adjusting table 25 is not smaller than that in the target rebuild load table 24 in S27 (see the NO route in step S27), the region-for-rebuild selector 14, in step S29, determines whether there is any next candidate spare region in the current layout pattern.

If there is a next candidate spare region (see the YES route in step S29), the region-for-rebuild selector 14 selects the next candidate in step S30 and returns to step S27, where the region-for-rebuild selector 14 determines whether the next candidate can be used.

If there is no next candidate (see the NO route in step S29), the optimization of this layout pattern is complete. In step S31, the region-for-rebuild selector 14 determines whether there is any layout pattern yet to be optimized.

If there is a layout pattern yet to be optimized (see the NO route in step S31), the region-for-rebuild selector 14 sets the next layout pattern for processing in step S32 and returns to step S26.

If the optimization of all layout patterns is complete (see the YES route in step S31), the region-for-rebuild selector 14 terminates the fast rebuild optimizing procedure, and the rebuild executor 15 starts an actual rebuild procedure.

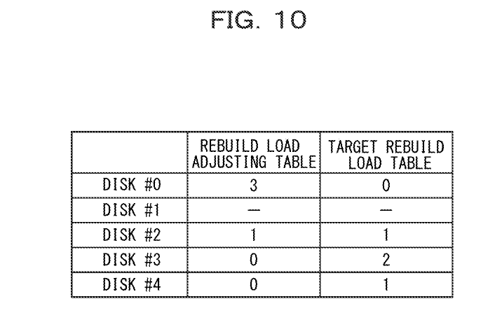

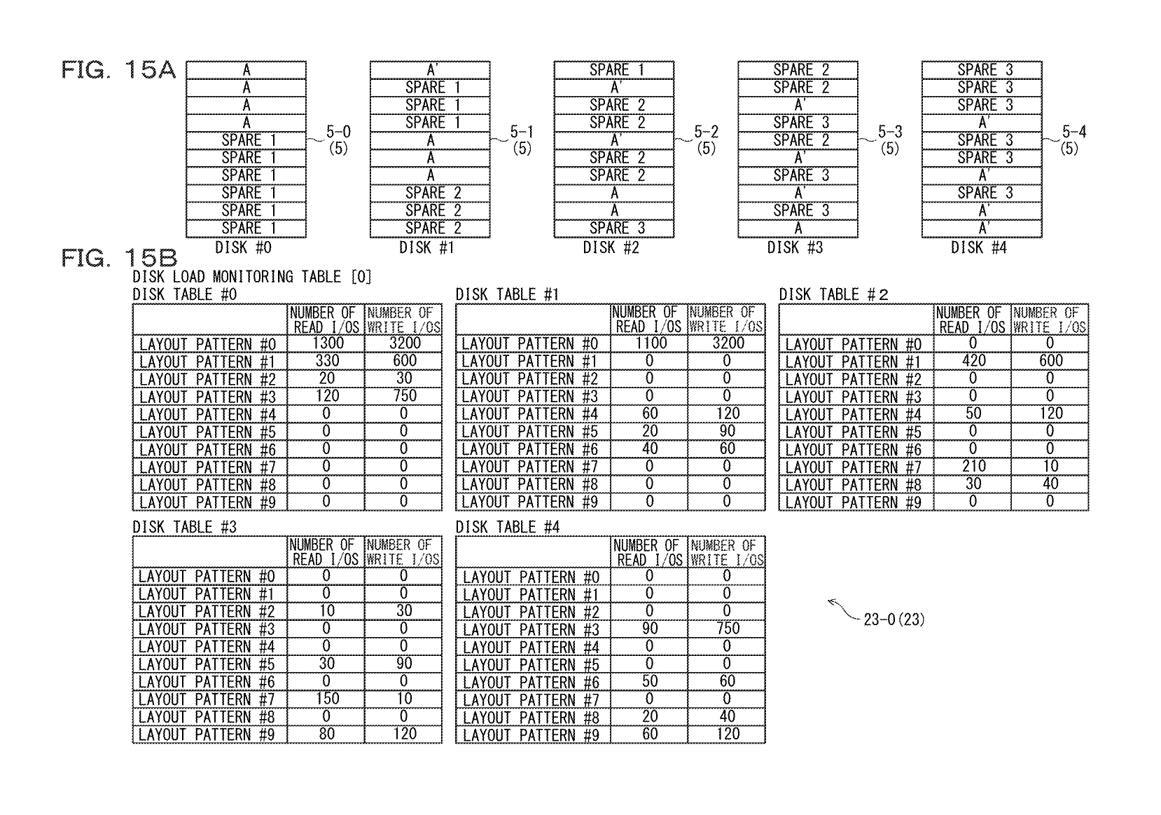

FIGS. 10 to 14 illustrate sets of example values of the rebuild load adjusting table 25 and the target rebuild load table 24 in the disk array apparatus 2 according to this embodiment. These examples use the layout patterns shown in FIG. 15A, as will be described later.

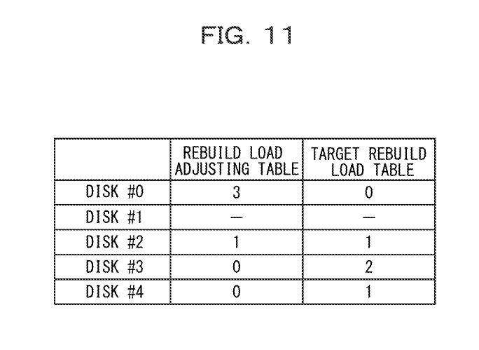

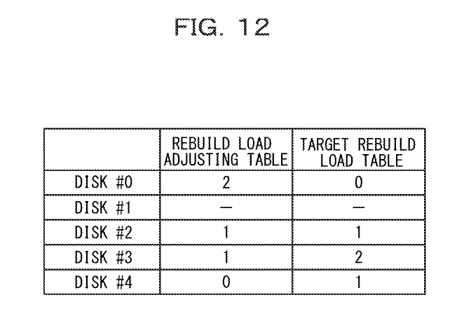

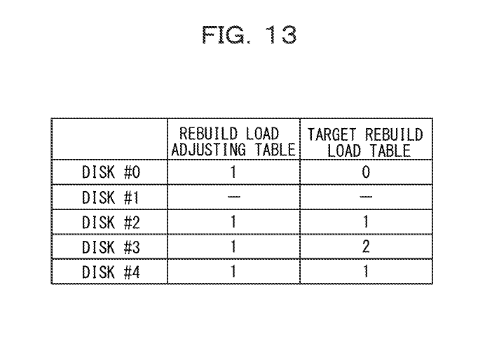

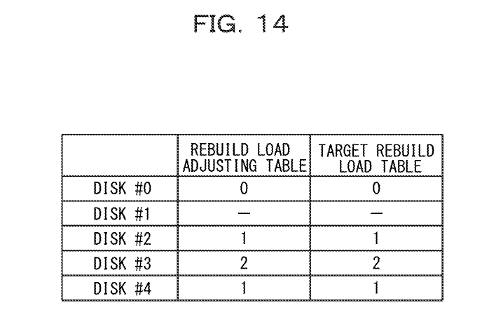

FIG. 10 illustrates a set of example values of the rebuild load adjusting table 25 and the target rebuild load table 24 after step S24 in FIG. 9 is executed. FIG. 11 illustrates a set of example values of the rebuild load adjusting table 25 and the target rebuild load table 24 after steps S26 to S31 in FIG. 9 are executed on the layout patterns #0 to #3. FIG. 12 illustrates a set of example values of the rebuild load adjusting table 25 and the target rebuild load table 24 after steps S26 to S31 in FIG. 9 are executed on the layout pattern #4. FIG. 13 illustrates a set of example values of the rebuild load adjusting table 25 and the target rebuild load table 24 after steps S26 to S31 in FIG. 9 are executed on the layout pattern #5. FIG. 14 illustrates a set of example values of the rebuild load adjusting table 25 and the target rebuild load table 24 after steps S26 to S31 in FIG. 9 are executed on the layout pattern #6.

An example fast rebuild optimizing procedure executed by the controller 11 of the disk array apparatus 2 according to this embodiment will now be described with reference to FIGS. 15 to 18.

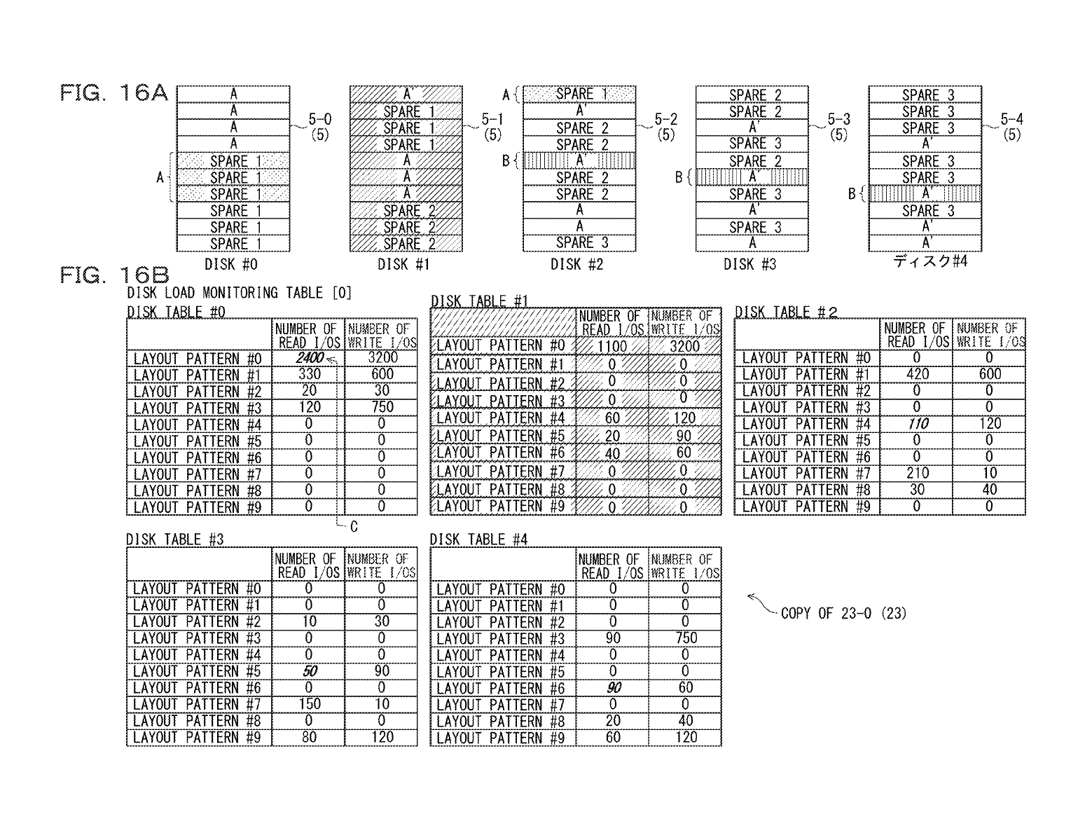

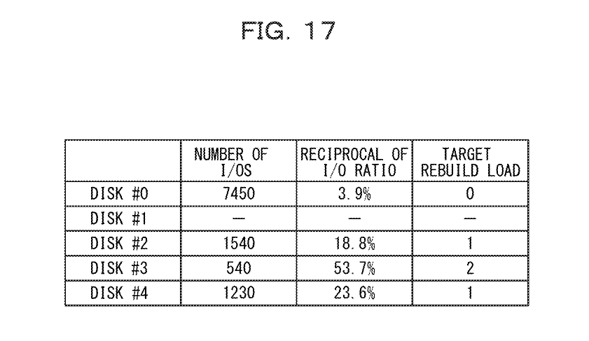

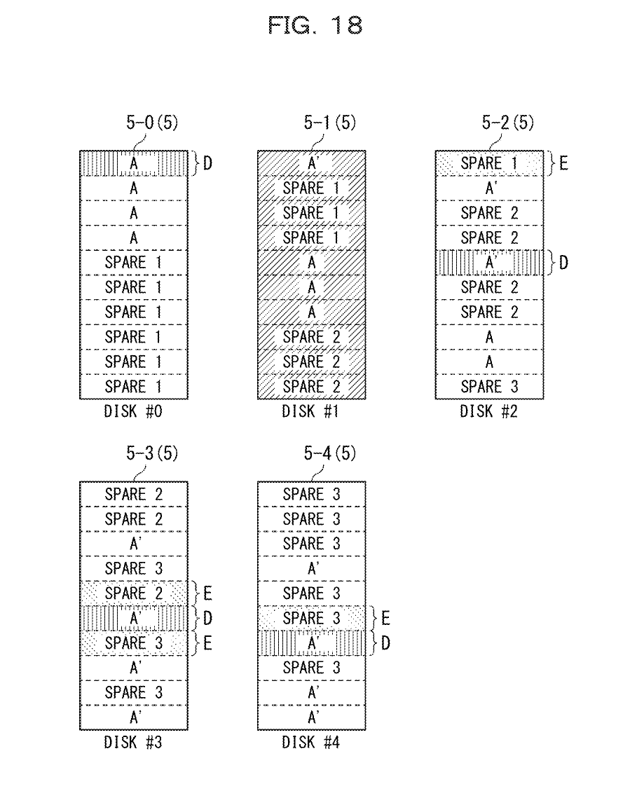

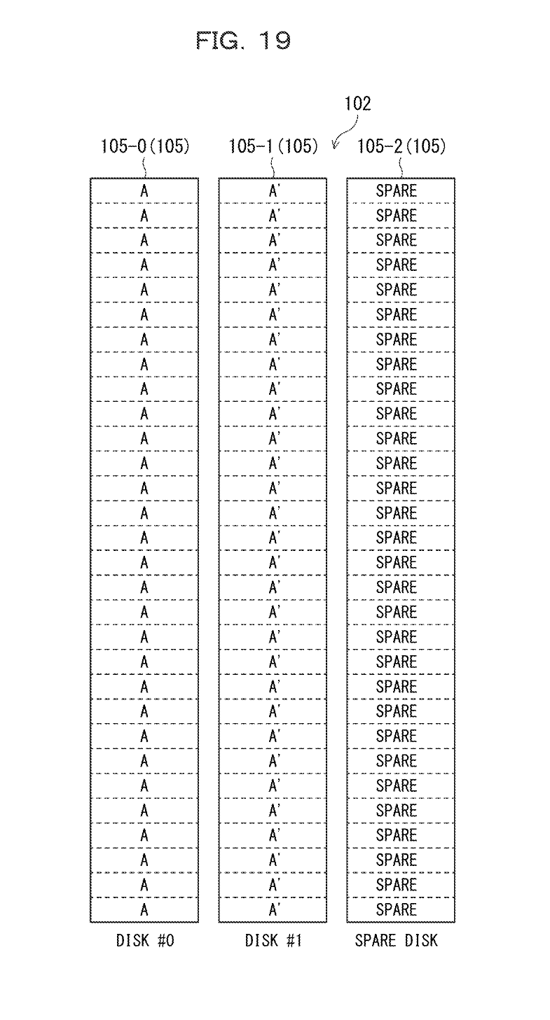

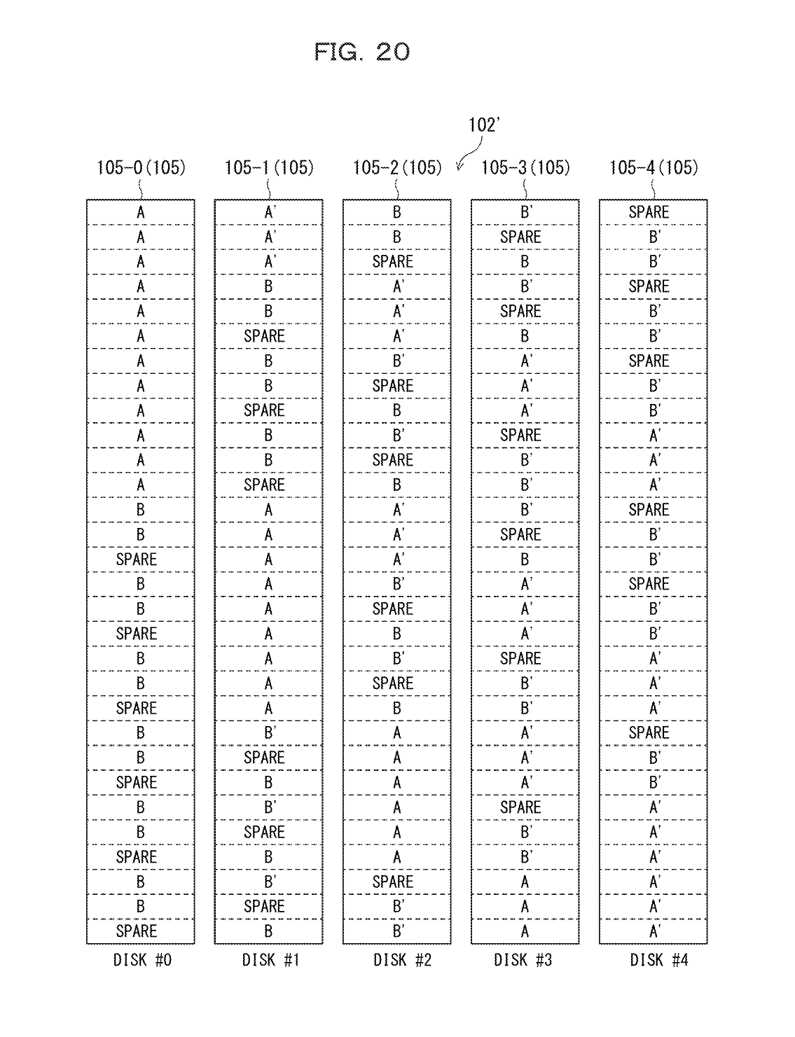

FIG. 15A illustrates a layout pattern table 21 of the disk array apparatus 2 according to this embodiment before a disk failure. FIG. 15B illustrates an example disk load monitoring table 23 in this example. FIG. 16A illustrates a layout pattern table 21 of the disk array apparatus 2 according to this embodiment after a disk failure. FIG. 16B illustrates an example disk load monitoring table 23 in this example. FIG. 17 illustrates example calculated results during the fast rebuild optimizing procedure executed by the region-for-rebuild selector 14. FIG. 18 illustrates an example layout pattern table after the fast rebuild optimizing procedure executed by the region-for-rebuild selector 14.

In the example in FIGS. 15 to 18, five disks 5, i.e., disks 5-0 to 5-4 (disks #0 to #4), define a virtual RAID group, and spare regions 1 to 3 on three of the disks 5 are allocated to each chunk set.

As shown in FIG. 15B, chunks A and A′ that define one chunk set store redundant data. If any disk 5 fails, the data on the failed disk 5 is reconstructed to the spare chunks in the chunk sets. Each chunk set includes the spare regions 1 to 3 as spare chunks on three disks 5.

The active disk load monitoring table 23-0 in this example is illustrated in FIG. 15B.

As shown in FIG. 15B, chunks that define a redundant pair have the same write I/O count. For example, the write I/O count of the layout pattern #0 of the disk table #0 and the write I/O count of the layout pattern #0 of the disk table #1 are both 3,200, and the write I/O count of the layout pattern #1 of the disk table #0 and the write I/O count of the layout pattern #1 of the disk table #2 are both 600.

In the example shown in FIG. 15B, accesses are concentrated in the leading regions of the disks #0 and #1.

It is assumed that the disk 5-1 (disk #1) fails.

FIGS. 16A and 16B illustrate a layout pattern table 21 and a disk load monitoring table 23 after a failure of the disk #1. The failed disk #1 is hatched.

In FIG. 16A, the shaded chunks (indicated by A) are the spare regions set for rebuild by the region-for-rebuild selector 14. The vertically striped chunks (indicated by B) should be read for rebuild.

The region-for-rebuild selector 14 creates a copy of the active disk load monitoring table 23-0 and adds the read I/O counts of the disk #1 to those of the disks 5 that define a redundant pair therewith. For example, the region-for-rebuild selector 14 adds the read I/O count of the layout pattern #0 of the disk table #1, i.e., 1,100, to that of the layout pattern #0 of the disk table #0 that defines a redundant pair therewith, i.e., 1,300. As shown in italics (indicated by arrow C) in FIG. 16B, the region-for-rebuild selector 14 changes the count of the layout pattern #0 of the disk table #0 that defines a redundant pair to 2,400 (=1,300+1,100). The region-for-rebuild selector 14 then adds up the numbers of read I/Os and the numbers of write I/Os of all layout patterns. The resulting number of I/Os of the disk #0 is 7,540 (=2,400+3,200+330+600+20+30+120+750). Similarly, the region-for-rebuild selector 14 adds the read I/O counts of the disk #1 to those of the disks #2 to #4 that define a redundant pair therewith and calculate the number of I/Os of each disk 5. These calculated results are shown in the column “number of I/Os” in FIG. 17.

The region-for-rebuild selector 14 then calculates the reciprocal of the ratio of the number of I/Os of each disk 5 to the total number of I/Os. Specifically, the region-for-rebuild selector 14 calculates the total number of I/Os of the disk array apparatus 2 to be 10,760 (=7,450+1,540+540+1,230) from the table in FIG. 17. The region-for-rebuild selector 14 then calculates the number of I/Os of the disk #0 to be 7,450 (=2,400+3,200+330+600+20+30+120+750). The reciprocal of the ratio of the number of I/Os of the disk #0 to the total number of I/Os is 0.0389 . . . or 3.9% (=(10,760/7,450)/{(10,760/7,450)+(10,760/1,540)+(10, 760/540)+(10,760/1,230)}). The region-for-rebuild selector 14 also executes the same calculations on the disks #2 to #4. These calculated results are shown in the column “reciprocal of I/O ratio” in FIG. 17.

The region-for-rebuild selector 14 then calculates the number of spare regions of each disk 5 to be used for rebuild. Specifically, the region-for-rebuild selector 14 multiplies the total number of chunks A and A′ on the failed disk #1, i.e., 4, by the reciprocal of the I/O ratio of each disk 5 and rounds the product into an integer to calculate the number of spare regions. These results are shown in the column “target rebuild load” in FIG. 17.

The region-for-rebuild selector 14 may round the product into an integer by a technique known in the art, which is not described in detail herein. The region-for-rebuild selector 14 writes the calculated values in the column “target rebuild load” in FIG. 17 to the target rebuild load table 24 (see FIG. 5).

The region-for-rebuild selector 14 executes the fast rebuild optimizing procedure in FIG. 9 with reference to the target rebuild load table 24. As a result, the region-for-rebuild selector 14 finally selects the shaded regions (indicated by E) in FIG. 18 for the spare regions for rebuild to optimize the fast rebuild depending on the I/O load on each disk 5.

In FIG. 18, the chunks indicated by D should be read for rebuild, and the chunks indicated by E are the spare regions selected for rebuild by the region-for-rebuild selector 14. The region-for-rebuild selector 14 skips the disk #0, which has a higher I/O load, and instead uses more chunks from the disk #3, which has a lower I/O load.

Although FIGS. 15 to 18 show a small layout having 10 layout combinations for illustration purposes, a larger number of layout combinations allows the region-for-rebuild selector 14 to execute more effective rebuild optimization.

### (C) ADVANTAGES

In the controller 11 according to this embodiment, the I/O load monitor 13 monitors the I/O load, such as the number of commands issued from the host 8 to each disk 5 that defines a virtual RAID group and the amount of accessed data, and summarizes the results of each layout pattern in the disk load monitoring table 23. If any disk 5 fails, the region-for-rebuild selector 14 selects the spare regions for fast rebuild based on the above statistics collected by the I/O load monitor 13 to optimize the fast rebuild.

This allows the region-for-rebuild selector 14 to skip a disk 5 having a higher I/O load and instead select more spare regions from a disk 5 having a lower I/O load.

As a result, the I/O load associated with fast rebuild is distributed over the disks 5, which shortens the time taken for fast rebuild.

A load associated with I/Os may concentrate on a particular disk, depending on the scheme of assignment of user data to the virtual RAID group and the scheme of access thereto. In the event of a disk failure in such a state, a higher performance will be achieved if a disk having a lower I/O load is preferentially used for rebuild than if all disks are uniformly accessed for rebuild.

Accordingly, in such a case, the disk used for rebuild is selected depending on the I/O load to optimize the load balance during the fast rebuild, which shortens the rebuild time of the disk array apparatus.

The I/O load monitor 13 switches the active disk load monitoring table 23 every specified time. Thus, if the region-for-rebuild selector 14 refers to the active disk load monitoring table 23 at the start of fast rebuild, it can optimize the fast rebuild based on statistics containing, for example, at least 30 minutes of data.

### (D) MODIFICATIONS

Various modifications can be made to the above embodiment without departing from the spirit of the embodiment.

For example, whereas the above embodiment illustrates a RAID-1-based virtual RAID group, the above embodiment is also applicable to other RAID levels. For example, the above embodiment is applicable to a RAID 5 or RAID 6 configuration that defines a virtual RAID group having a plurality of spare regions in each chunk set.

Whereas the above embodiment illustrates the disks 5 as HDDs, the disks 5 may be other types of storage devices, such as solid state drives (SSDs).

The above embodiment illustrates an example where the active disk load monitoring table 23 is switched every 30 minutes; however, the statistics need to be collected only for the time required for rebuild. The time after which the active disk load monitoring table 23 is switched may be set depending on the configuration of the virtual RAID group.

The embodiments discussed herein shorten the rebuild time of a disk array apparatus.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

1. A storage control apparatus for controlling a storage system comprising a plurality of storage devices, the storage control apparatus comprising:
a monitor unit that collects statistics from each of the storage devices; and
a selection unit that, in the event of a failure of any of the storage devices, selects a storage device to which data in the failed storage device is to be reconstructed, based on the statistics collected by the monitor unit.

2. The storage control apparatus according to claim 1, wherein the monitor unit collects the statistics for each of the storage devices.

3. The storage control apparatus according to claim 1, wherein the statistics are an input/output load on each of the storage devices.

4. The storage control apparatus according to claim 3, wherein the monitor unit collects an input/output load comprising the number of commands issued to each of the storage devices and the amount of accessed data.

5. The storage control apparatus according to claim 3, wherein the selection unit preferentially selects a storage device having a lower input/output load for the storage device to which the data is to be reconstructed for each chunk of a predetermined size.

6. The storage control apparatus according to claim 5, wherein the storage devices have a plurality of spare chunks for the chunks of stored data.

7. A method of controlling a storage system comprising a plurality of storage devices, the method comprising:
collecting statistics from each of the storage devices; and
in the event of a failure of any of the storage devices, selecting a storage device to which data in the failed storage device is to be reconstructed based on the collected statistics.

8. The method according to claim 7, wherein the statistics are collected for each of the storage devices.

9. The method according to claim 7, wherein the statistics are an input/output load on each of the storage devices.

10. The method according to claim 9, wherein an input/output load comprising the number of commands issued to each of the storage devices and the amount of accessed data is collected.

11. The method according to claim 9, wherein a storage device having a lower input/output load is preferentially selected for the storage device to which the data is to be reconstructed for each chunk of a predetermined size.

12. The method according to claim 11, wherein the storage devices have a plurality of spare chunks for the chunks of stored data.

13. A non-transitory computer-readable storage medium storing a storage control program for controlling a storage system comprising a plurality of storage devices, the storage control program causing a computer to execute:
collecting statistics from each of the storage devices; and
in the event of a failure of any of the storage devices, selecting a storage device to which data in the failed storage device is to be reconstructed based on the collected statistics.

14. The non-transitory computer-readable storage medium according to claim 13, wherein the storage control program causes the computer to collect the statistics for each of the storage devices.

15. The non-transitory computer-readable storage medium according to claim 13, wherein the statistics are an input/output load on each of the storage devices.

16. The non-transitory computer-readable storage medium according to claim 15, wherein the storage control program causes the computer to collect an input/output load comprising the number of commands issued to each of the storage devices and the amount of accessed data.

17. The non-transitory computer-readable storage medium according to claim 15, wherein the storage control program causes the computer to preferentially select a storage device having a lower input/output load for the storage device to which the data is to be reconstructed for each chunk of a predetermined size.

18. The non-transitory computer-readable storage medium according to claim 17, wherein the storage devices have a plurality of spare chunks for the chunks of stored data.
